(19) United States
(12) Patent Application Publication
(10) Pub. No.: US 2008/0111008 A1
(43) Pub. Date: May 15, 2008

(54) Shrouded Attrition Nozzle and Method of Use Thereof

(76) Inventor: Craig HULET, London (CA)

Correspondence Address: BRUNET & CO. LTD., 10712 MELROSE DR., KOMOKA, ON, N0L-1R0, omitted

(21) Appl. No.: 11/558,884

(22) Filed: Nov. 10, 2006

(51) Int. Cl. B02C 19/06; B02C 23/02

(52) U.S. Cl. 241/5; 241/39; 241/38

(57) ABSTRACT

A shrouded attrition nozzle for use in fluidized bed jet attrition. The nozzle comprises a shroud surrounding the nozzle and extending upwardly from the nozzle tip. The shroud is sized so as not to interfere with the periphery of the jet emitted from the nozzle and may be cylindrical or inverted frustoconical in shape. When a desired spacing is achieved between the periphery of the jet and the shroud, fluidizable material enters the interior of the shroud from the open end, moving countercurrently towards the nozzle tip. A disengagement of fluidization gas from fluidizable material occurs and an increased entrainment of solids in the jet leads to improvements in grinding efficiency. The result is a reduction in jet flowrate and fluidization gas wastage, which reduces overall energy requirements for attrition. A method of causing attrition of a fluidizable material using the shrouded nozzle is also disclosed.

### FIELD OF THE INVENTION

The invention relates to a shrouded attrition nozzle for causing attrition of a fluidizable media in a fluidized bed. More particularly, the invention relates to a shrouded attrition nozzle wherein the shroud is larger in diameter than the nozzle body and extends above the nozzle body such that there is a predetermined clearance between the shroud and an edge of a jet of gas exiting the nozzle. A method of using the nozzle to cause attrition in a fluidized bed is also disclosed.

### BACKGROUND

Gas-solid fluidized beds are used in many industrial applications such as polyethylene production, drying, coating, granulation, fluid catalytic cracking and fluid coking. For some industrial applications, controlling the size distribution of the particles in a fluid bed is extremely important in order to avoid poor fluidization. One method to control the size of the particles in the bed is to use attrition nozzles, which inject high velocity gas jets into the bed creating high shear regions and grinding particles together. Because the grinding in fluidized bed jet attritors is autogenous, there is no contamination of the ground product by fragments from grinding surfaces, as in most other grinders. Jet mills are, therefore, used to grind materials such as toners, high purity ceramics, foodstuffs, ultrafine metal oxides, pharmaceutical powders, pigments, polymer powders and ultrafine particles for powder coating.

One application in particular, the fluid coking process, uses thermal cracking to upgrade bitumen extracted from oil sands to produce synthetic crude oil. During the fluid coking process there is a gradual increase in the size of the coke particles due to the formation and deposition of coke byproduct on the surface of the particles during the reaction. In addition to particle growth due to the reaction, agglomerates are also formed when several coke particles stick together as a result of the injection of the liquid bitumen feed. Controlling the particle size of the coke within the fluid coker is of great importance, since large particles will result in slugging and poor circulation. Conversely, if too many fine particles with a diameter less than 70 microns exist, excessive particle entrainment will occur. In order to control the size of the particles in the fluid coker, steam is injected into the reactor section through attrition nozzles. The high velocity gas jet issuing from these nozzles entrains bed particles and accelerates them to a high speed. Due to their inertia, these particles slam on slow moving bed particles near the jet tip, causing breakage and, thus, reducing the particle size.

Currently, attrition nozzles require a large proportion of the total steam consumed by the fluid cokers. If attrition nozzles could be improved to achieve the same attrition rates with a much lower steam flowrate, the production rate of synthetic crude from the fluid cokers could be greatly increased. An increase in attrition rate would be desirable in other applications as well. It would also be desirable to provide an increase in attrition rate and/or a corresponding decrease in nozzle flowrate using a solution that is inexpensive, retrofittable, and does not require extensive re-design of the fluidized bed system. It would be further desirable not to interfere with the autogenous nature of the grinding achieved in jet attrition.

Simple jet attrition in an unrestricted environment can be enhanced through the use of an impact target or a draft tube accelerator. These systems have the drawback of introducing foreign material into the bed due to erosion of the target or tube, thereby interfering with the autogenous nature of jet attrition.

Dunlop et al. (Dunlop, D., L. Griffin, J. Moser, “Particle Size Control in Fluid Coking.” Chem. Eng. Prog. 54(8), 39-43, 1958) found that grinding was enhanced by impacting the attrition jet on a target plate placed in the fluidized bed. However, implementation was complex since solids were supplied into the nozzle tube upstream of the fluidized bed, in order to be fully accelerated before entering the bed. Dunlop et al. also found that target grinding and regular jet grinding had similar power requirements, but that target grinding produced a smaller proportion of undesirable excessively fine particles. A major problem associated with target grinding was found to be the erosion of the target, leading to contamination of the material in the bed.

U.S. Pat. No. 5,133,504, filed by Smith et al. and issued Jul. 28, 1992, proposes the use of both an impact target and a draft tube downstream and coaxial with the attrition nozzle. The purpose of the draft tube is to accelerate the particles entrained into the jet by maintaining a high gas velocity over a significant distance. This creates a sustained high particle velocity that leads to increased attrition due to an increase in impact energy. The environment around the nozzle is unrestricted in this system. However, draft tubes can require system re-design to implement in a retrofit situation and erosion of the draft tubes and/or target can also be significant.

In fluidized bed jet attrition, fluidization gas is drawn towards the nozzle tip as a result of the pressure differential between the rapidly expanding jet and the turbulent shear layers that are created at the jet/bed interface. The entrained fluidization gas drags the fluidized particles towards the jet. The location at which solids enter the jet and their entrance velocity affect the depth of penetration into the jet, which in turn has an impact on subsequent solids acceleration and jet expansion. Particle size and density, as well as the gas density and velocity, also influence the entrainment rate and jet penetration.

Most of the experimental research on jet attrition has been done using straight tube nozzles in an unrestricted environment where solids are free to approach the nozzle tip from any direction. The environment surrounding the nozzle tip may be an important parameter which affects solids entrainment. This parameter has not been previously studied and no systems exist wherein the environment surrounding the nozzle tip is influenced with shrouds or other bodies placed in the fluidized bed, especially for the purpose of increasing solids concentration and/or gas recirculation in the vicinity of the nozzle tip.

U.S. Pat. No. 7,025,874, filed by Chan et al. and issued Apr. 11, 2006, discloses a nozzle/mixer assembly for use in mixing a stream of hot coke particles in a fluidizing gas with a jet of atomized liquid oil droplets being injected into the fluidized bed of a fluid coker. The nozzle/mixer assembly includes an atomizing nozzle extending horizontally through a side wall of the coker into the open inlet of a venturi shaped draft tube. The venturi and jet combine to create a low pressure condition that draws a stream of solid particles and fluidizing gas into the open inlet of the venturi. The entrained stream and jet mix vigorously as they pass together through the venturi and exit from the opposite open end. FIG. 6 shows a long draft tube that extends over the nozzle and includes bottom openings for admitting solids into the tube in the relatively unrestricted environment of the nozzle tip. The mixer therefore has two open ends and solids are encouraged to enter from one end and exit from the other. It is important to note that this is a mixer and that the objective is therefore to maximize gas entrainment, not jet penetration by solids. No study was made of attrition using this system.

U.S. Pat. No. 5,437,889, filed by Jones and issued Aug. 1, 1995, relates to a fluidized bed spray coating system of the Wurster type. The system includes a fluidized bed with an interior partition or draft tube with an open bottom. A spray nozzle is located within the draft tube and issues a high velocity air jet that is used to atomize the liquid spray materials. Solids are drawn into the open bottom of the tube from the fluidized bed and are coated with that atomized liquid. A shield is provided around the nozzle to prevent particles from entering the spray pattern at the nozzle tip before the pattern is fully developed. The objective is therefore to keep particles out of the jet, particularly at the nozzle tip located on the interior of the shield. Attrition of the solid particles was not studied.

The need therefore still exists for improved jet attrition nozzles, particularly nozzles that influence the environment surrounding the nozzle tip, are retrofittable and do not interfere with the autogenous nature of jet attrition.

### SUMMARY OF THE INVENTION

According to an aspect of the present invention, there is provided a shrouded attrition nozzle for use in a vessel containing a fluidized bed of a fluidizable media, the nozzle comprising: a nozzle body having a nozzle height and an orifice at one end with an inner diameter for emitting a high velocity gas jet into the fluidized bed, the gas jet having a jet angle between a periphery of the jet and a normal to the orifice; a shroud having a shroud height, an interior within which the nozzle body is centrally located, an interior diameter, a first end that is open and a second end that prevents passage of the media into the interior; the relationship between the nozzle height (h), the orifice inner diameter (d), the jet angle (θ), the shroud height (H) and the shroud interior diameter (D) defined by,

$$C = \frac{D - d}{2} - ( H - h ) tan ( θ )$$

wherein C represents the distance between the periphery of the jet and the shroud across the first end and is from 1 to 100 mm.

According to another aspect of the present invention, there is provided a method of causing attrition of a fluidizable media comprising: providing a vessel containing a fluidizable media and a shrouded attrition nozzle comprising a nozzle body having an orifice at one end and a shroud having an interior within which the nozzle body is centrally located, a first end that is open and a second end that prevents passage of the media into the interior; creating a fluidized bed by flowing a fluidizing gas through the fluidizable media within the vessel; directing a flow of gas through the nozzle body; emitting a high velocity gas jet from the orifice into the fluidized bed; admitting the fluidizable media into the interior of the shroud through the first end; and, entraining the admitted media with the jet at high velocity into the fluidized bed, thereby causing attrition of the media.

### BRIEF DESCRIPTION OF THE DRAWINGS

Having summarized the invention, preferred embodiments thereof will now be described with reference to the accompanying figures, in which:

FIG. 1 schematically shows a vessel containing a fluidized bed supported by a gas distributor with a shrouded attrition nozzle mounted vertically thereto in abutment therewith;

FIGS. 2a and 2b provide perspective views of two embodiments of a shrouded attrition nozzle;

FIG. 3 schematically shows a cross-section of a shrouded attrition nozzle including a reference geometry;

FIG. 4 schematically shows a perspective view of a shrouded attrition nozzle including a transverse target spaced apart from the shroud;

FIG. 5 schematically shows a shrouded attrition nozzle used in conjunction with a draft tube spaced apart from the shroud;

FIG. 6 shows the solids entrainment rate Fₛ (kg/h) as a function of the percentage distance shrouded between the nozzle tip and the draft tube (l_{D}), which is equivalent to H−h;

FIG. 7 shows the fluidization gas entrainment rate F_{g, ent} (kg/h) as a function of the percentage distance shrouded between the nozzle tip and the draft tube (l_{D}), which is equivalent to H−h;

FIG. 8 is a perspective cross-sectional view of an embodiment of a shrouded attrition nozzle having an inverted frustoconical interior shape; and,

FIG. 9 schematically shows the experimental apparatus used in obtaining the Example data.

### DETAILED DESCRIPTION OF PREFERRED EMBODIMENTS

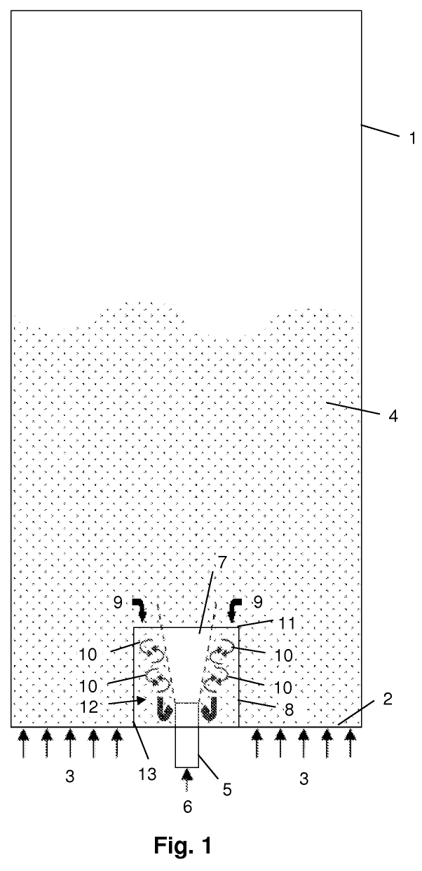

Referring to FIG. 1, a fluidized bed jet attrition apparatus comprises a vessel 1 containing a gas distributor 2 through which a flow of a fluidizing gas 3 is introduced into a fluidizable material 4 (also referred to herein as “solids”). The fluidizing gas 3 causes the fluidizable material 4 to expand and form a fluidized bed. One or more jet attrition nozzles 5 are provided and oriented either horizontally, vertically (as shown), or combinations of the two orientations may be provided. Regardless of the jet orientation, a flow of nozzle gas 6 is provided through the nozzle 5, causing a jet 7 to issue from the nozzle into the fluidized bed. The jet 7 expands from a circular orifice in the nozzle tip in a generally conical fashion, although other orifice shapes may also be used to produce, for example, fan-shaped jets. Once the jet 7 is established, a certain amount of space exists between the periphery of the jet and the perimeter of an open end of a shroud 8. Through this space, the fluidizable material 4 moves into the interior of the shroud 8, countercurrent to the jet 7, as indicated by arrows 9. One or more recirculation zones, indicated by arrows 10, are established within the interior of the shroud 8 where the fluidizing gas 3 in which the fluidizable material 4 is entrained is separated from the material. The separated gas then recirculates back to the shroud opening and acts as a shuttle, bringing more material from the fluidized bed into the interior of the shroud 8. This leads to a localized increase in solids concentration within the shroud 8 relative to the rest of the fluidized bed and a decrease in entrainment of the fluidizing gas 3 into the jet 7. The recirculation zones 10 also are regions of relatively low pressure, which helps to bring more of the material 4 into the shroud 8. The material 4 is drawn towards the tip of the nozzle 5, where it is entrained in the jet 7; this is in contrast to conventional unshrouded nozzles, where the material is permitted to enter the jet all along its periphery. The localized increase in solids concentration within the shroud 8 causes a high degree of solids entrainment in the jet 7, which in turn leads to improved grinding efficiency.

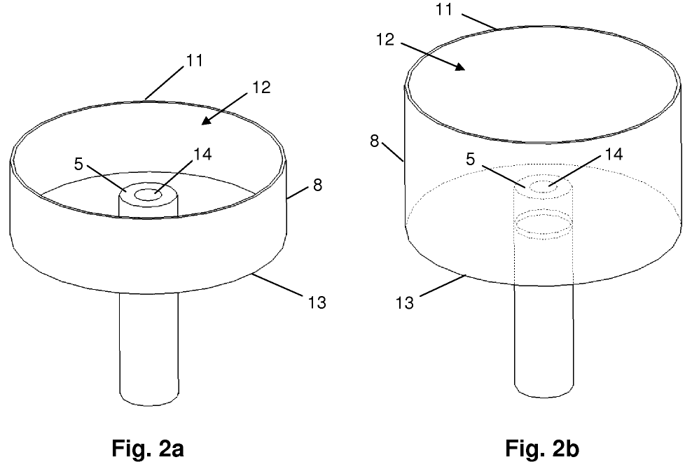

FIGS. 2a and 2b show perspective views of two embodiments of a shrouded attrition nozzle as previously described. The shroud 8 has a first end 11 that is open, allowing the fluidizable material 4 to enter the interior of the shroud (generally denoted as 12) and a second end 13 that prevents the passage of the material into the interior. The second end 13 may be closed (as shown) and optionally sealed to the nozzle 5 or may be open but in abutment with an interior surface of the vessel. The interior surface may comprise, for example, a side wall of the vessel, a gas distributor, or any other suitable surface. The second end 13 may be sealed to the surface relative to the passage of the fluidizable material 4 to thereby prevent entry of the material into the interior 12. Permitting material to enter the interior of the shroud 12 through the second end 13 would disrupt the recirculating countercurrent flow pattern desired to be established and would have a detrimental effect on attrition. The nozzle 5 protrudes from the second end 12 into the interior of the shroud 12. Although a straight nozzle 5 with a circular orifice 14 is shown, a number of different nozzle types and orifice configurations can be used. Since the jet 7 does not actually contact the perimeter of the first end 11, erosion of the shroud 8 is not a significant concern and the shroud 8 does not generally interfere with the autogenous nature of the jet attrition. The shroud 8 is retrofittable to existing attrition nozzle installations and the diameter and/or height of the shroud may be selected based upon pre-existing nozzle dimensions in a manner as will be more thoroughly described hereinafter.

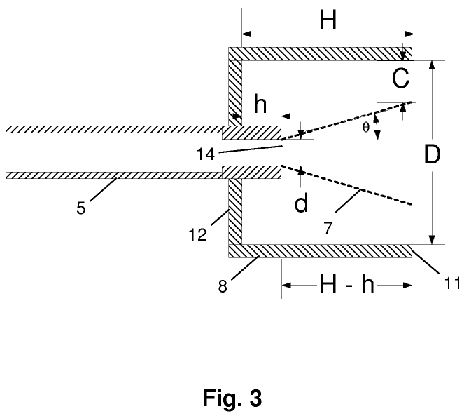

Referring to FIG. 3, an embodiment of a shrouded attrition nozzle according to the invention is shown in cross-sectional view and labeled for dimensional reference. The shroud 8 has an interior diameter D and a height H. The nozzle 5 extends through the closed second end 12 by a nozzle height h and has an orifice 14 at one end (the nozzle tip) with an internal diameter d. A conical jet 7 extends from the nozzle tip in a direction normal to the plane of the orifice. A jet angle θ is defined between the periphery of the jet and the normal to the orifice. The jet angle θ depends upon a number of factors that may include, for example, the jet velocity, density of the gas or steam exiting the nozzle, shape of the orifice, length of straight nozzle section preceding the orifice, etc. The calculation of jet angle or jet half-angle is known to persons skilled in the art and may be found in a number of publications, for example Merry, J. M. D. “Penetration of vertical jets into fluidized beds”, AlChE Journal, v. 21, n. 3, pp. 507-510, 1975, which is incorporated herein by reference. Merry provides a correlation for jet half angle as:

L/dₒ=[cot(θ)(D_{b}−1)]/[2dₒ] (1)

where L=penetration length, dₒ=orifice size, D_{b}=diameter of initial bubbles, and θ=jet half angle. This equation can be simplified to:

cot(θ)=10.4[(ρₚdₚ)/(ρ_{f}dₒ)]^{-0.3} (2)

where ρₚ=particle density, ρ_{f}=fluid density and dₚ=particle size.

The space between the perimeter of the shroud 8 at its first end 11 and the periphery of the jet 7 as defined by its jet angle θ is denoted as C. The value of C can be calculated by the following equation:

$$D = 2 C + 2 ( H - h ) tan ( θ ) + d \\ C = \frac{D - d}{2} - ( H - h ) tan ( θ ) \qquad ( 3 )$$

When C is small, there is very little space for the fluidizable material 4 to enter the interior 12 of the shroud 8 through the first end 11 between the shroud and the periphery of the jet 7. However, as C increases to a large value, the shroud ceases to have an effect and the jet reverts to unshrouded behaviour. There is therefore an optimum value of C that promotes solids entering the interior 12 of the shroud and circulating towards the nozzle tip. This value lies somewhere between 1 and 100 mm. Various combinations of the parameters H, h, D, d and θ may be used to arrive at a value for C. Some examples of these combinations are provided in Table 1.

TABLE 1
Combinations of parameters that provide C from 1 to 100 mm.

| D (mm) | d (mm) | H (mm) | h (mm) | θ (°) | C (mm) |
|---|---|---|---|---|---|
| 44 | 4.6 | 19 | 6.4 | 15 | 16.3 |
| 30 | 4.6 | 19 | 6.4 | 15 | 9.3 |
| 40 | 4.6 | 19 | 6.4 | 15 | 14.3 |
| 45 | 4.6 | 19 | 6.4 | 15 | 16.8 |
| 50 | 4.6 | 19 | 6.4 | 15 | 19.3 |
| 55 | 4.6 | 19 | 6.4 | 15 | 21.8 |
| 60 | 4.6 | 19 | 6.4 | 15 | 24.3 |
| 70 | 4.6 | 19 | 6.4 | 15 | 29.3 |
| 80 | 4.6 | 19 | 6.4 | 15 | 34.3 |
| 90 | 4.6 | 19 | 6.4 | 15 | 39.3 |
| 44 | 4.6 | 10 | 6.4 | 15 | 18.7 |
| 44 | 4.6 | 15 | 6.4 | 15 | 17.4 |
| 44 | 4.6 | 20 | 6.4 | 15 | 16.1 |
| 44 | 4.6 | 30 | 6.4 | 15 | 13.4 |
| 44 | 4.6 | 40 | 6.4 | 15 | 10.7 |
| 44 | 4.6 | 50 | 6.4 | 15 | 8.0 |
| 44 | 4.6 | 60 | 6.4 | 15 | 5.3 |
| 44 | 4.6 | 70 | 6.4 | 15 | 2.7 |
| 46 | 4.6 | 80 | 6.4 | 15 | 1.0 |
| 44 | 1.5 | 19 | 6.4 | 15 | 17.9 |
| 44 | 2.5 | 19 | 6.4 | 15 | 17.4 |
| 44 | 3.5 | 19 | 6.4 | 15 | 16.9 |
| 44 | 4.5 | 19 | 6.4 | 15 | 16.4 |
| 44 | 5.5 | 19 | 6.4 | 15 | 15.9 |
| 44 | 6.5 | 19 | 6.4 | 15 | 15.4 |
| 44 | 4.6 | 19 | 2.5 | 15 | 15.3 |
| 44 | 4.6 | 19 | 4.5 | 15 | 15.8 |
| 44 | 4.6 | 19 | 6.5 | 15 | 16.4 |
| 44 | 4.6 | 19 | 8.5 | 15 | 16.9 |
| 44 | 4.6 | 19 | 10.5 | 15 | 17.4 |
| 44 | 4.6 | 19 | 12.5 | 15 | 18.0 |
| 44 | 4.6 | 19 | 6.4 | 10 | 17.5 |
| 44 | 4.6 | 19 | 6.4 | 12 | 17.0 |
| 44 | 4.6 | 19 | 6.4 | 14 | 16.6 |
| 44 | 4.6 | 19 | 6.4 | 16 | 16.1 |
| 44 | 4.6 | 19 | 6.4 | 18 | 15.6 |
| 44 | 4.6 | 19 | 6.4 | 20 | 15.1 |
| 90 | 1.5 | 10 | 8.5 | 10 | 44.0 |
| 100 | 10 | 45 | 15 | 15 | 37.0 |
| 150 | 15 | 67.5 | 22.5 | 15 | 55.4 |
| 200 | 20 | 90 | 30 | 15 | 73.9 |
| 250 | 25 | 112.5 | 37.5 | 15 | 92.4 |

In one preferred embodiment, the parameter C is from 5 to 50 mm, more preferably from 5 to 20 mm. In another preferred embodiment, the jet angle θ is from 10 to 20 degrees, more preferably from 12 to 18 degrees, yet more preferably from 13 to 17 degrees, even more preferably from 14 to 16 degrees, still more preferably about 15 degrees. In yet another preferred embodiment, the shroud height H is from 5 to 120 mm, more preferably from 10 to 80 mm, yet more preferably from 15 to 50 mm. In still another preferred embodiment, the shroud interior diameter D is from 20 to 250 mm, preferably from 30 to 90 mm, more preferably from 35 to 70 mm, yet more preferably from 40 to 50 mm. In still another preferred embodiment, the nozzle height h from the second end 13 of the shroud is from 2 to 40 mm, preferably from 4.5 to 10 mm, yet more preferably from 5 to 7 mm. In even another preferred embodiment, the nozzle orifice diameter d is from 1 to 25 mm, preferably from 2 to 7 mm, more preferably from 3 to 6 mm, yet more preferably from 4 to 5 mm. A wide range of sub-combinations are available within these ranges that produce a value of C that delivers an acceptable level of improvement in grinding efficiency.

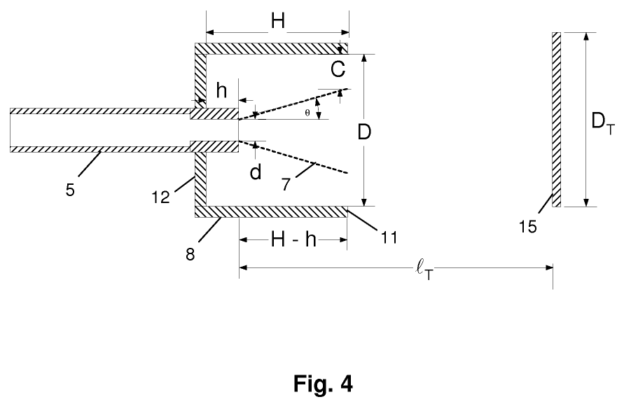

In order to further increase the grinding efficiency, the vessel may be equipped with a target 15 downstream of the nozzle 5 and spaced apart from the shroud 8. This configuration is shown schematically in FIG. 4. The target 15 provides a surface for impingement of particles, which leads to an increase in attrition rate in a manner as is conventionally known. Use of the target 15 in combination with the shroud 8 leads to an even greater improvement in grinding efficiency, due to the increased entrainment of solids in the jet 7 due to the shroud. The distance between the target 15 and the nozzle tip, l_{T}, is preferably sufficient that some space is provided between the first end of the shroud 11 and the target 15. The distance l_{T} may be from 40 to 150 mm, preferably from 50 to 100 mm, more preferably from 60 to 90 mm. The target 15 is preferably of a diameter equal to or greater than the diameter of the jet at the distance l_{T}. Generally, the target diameter is from 50 to 100 mm. The target 15 may be mounted to the shroud 8 using standoffs to form part of the shrouded attrition nozzle or may be mounted to some other structure within the vessel.

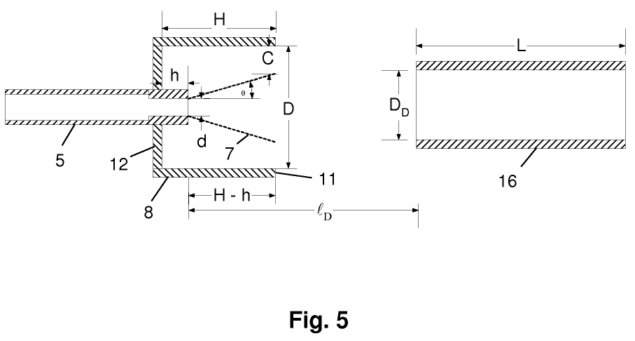

In order to yet further increase grinding efficiency and provide a desirable distribution of particle size without incurring too large of a percentage of fines, a draft tube 16 may be used in conjunction with the shrouded nozzle. The draft tube 16 is oriented coaxially with the jet 7 and spaced apart from the shroud 8, as shown in FIG. 5. The draft tube 16 tends to focus the entrained solids towards the center of the jet 7 rather than the periphery, leading to increased attrition. This function of the draft tube is also provided to a certain extent by the shroud, and the draft tube efficacy is most evident at certain preferred combinations of conditions. The distance between the draft tube inlet and the nozzle tip, l_{D}, is selected so that there is some exposed space between the first end of the shroud 11 and the draft tube 16. The distance l_{D} is preferably from 10 to 150 mm, more preferably from 15 to 100 mm, yet more preferably from 20 to 50 mm, still more preferably from 25 to 40 mm. The length of the draft tube L is selected to provide sufficient residence time within the tube to allow solids redistribution and attrition to occur and is generally in the range of 40 to 150 mm. The diameter of the draft tube D_{D} is selected so as to be roughly equal to the diameter of the jet at the distance l_{D} and is preferably from 20 to 50 mm. The jet diameter may be larger than D_{D} in some cases. The draft tube 16 may be a straight cylinder or any other suitable shape. The draft tube 16 may be mounted to the shroud 8 using standoffs to form part of the shrouded attrition nozzle or may be mounted to some other structure within the vessel.

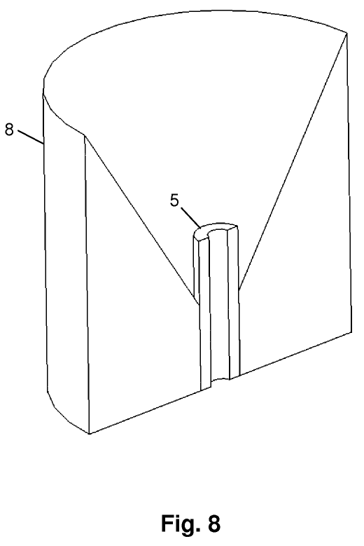

Although the shroud shown in previous embodiments has been cylindrical in shape, the shroud may have any suitable interior shape to promote solids movement toward the nozzle tip and/or fluidization gas recirculation. Referring to FIG. 8, another embodiment of the shroud 8 may have an inverted frustoconical interior shape. The shroud 8 may be cylindrical in exterior shape or may have a complementary inverted frustoconical exterior shape. The angle of the wall in the inverted frustoconical shroud is preferably greater than or equal to the angle of repose of the fluidizable material. The angle of the wall is preferably in the range of 25 to 75 degrees, preferably 30 to 60 degrees with respect to the transverse plane. Since the particles move countercurrently to the jet along its periphery, use of a frustoconical shroud aids in directing the solids towards the nozzle tip and occupies the “dead zones” where particles might otherwise accumulate. This leads to an increase in solids entrainment and a decrease in fluidization gas entrainment in certain situations as compared with a cylindrical shroud.

The shrouded nozzle according to the present invention may be used as part of a fluidized bed attrition system. Any size or configuration of shroud may be used with such a system, provided that the solids are admitted to the interior of the shroud through the first end. The fluidizable material preferably moves into the interior of the shroud countercurrently to the jet. The fluidizable material preferably moves towards the orifice at the nozzle tip while within the interior of the shroud. The fluidizable material preferably does not enter the jet periphery. The fluidizing gas entrained with the solids preferably disengages from the fluidizable material within the interior of the shroud. The fluidizing gas is preferably recirculated to the shroud opening to act as a shuttle in bringing more solids into the shroud. This creates one or more recirculation zones of relatively low pressure. The increase in solids entrainment as compared with an unshrouded nozzle is preferably accompanied by a concurrent decrease in fluidizing gas entrainment. The percentage increase in solids entrainment is preferably at least 50% as compared with an otherwise identical unshrouded nozzle, more preferably at least 75%, yet more preferably at least 100%. The grinding efficiency is preferably increased by at least 50% as compared with an unshrouded nozzle, more preferably at least 75%, yet more preferably at least 100%. The grinding efficiency is preferably at least 400 m²/kg, more preferably at least 450 m²/kg, yet more preferably at least 500 m²/kg.

### EXAMPLES

### Experimental Set-Up

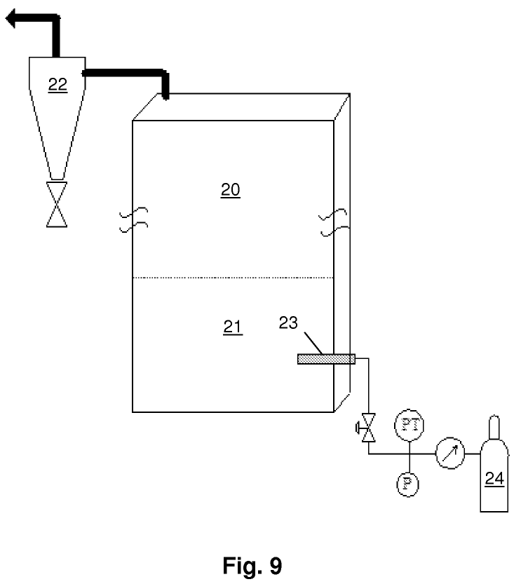

Attrition experiments were conducted in a fluidized column 20 with a height of 0.84 m and a rectangular cross section of 0.5 m by 0.1 m, as shown in FIG. 9. The solids were coke particles with a density of 1400 kg/m³ and a Sauter-mean diameter of 135 μm, which filled the column to a height of approximately 0.23 m. The bed 21 was fluidized with air at a velocity of 10 cm/s and the entrained particles were separated from the gas stream by a cyclone 22.

The attrition nozzle 23 was placed inside the bed at a distance of 0.1 m from the gas distributor, and injected gas horizontally into the fluidized particles in order to grind the particles. A constant gas mass flowrate from a high-pressure cylinder 24 was supplied to the injection nozzle during the grinding process. Adjusting the regulator pressure of the cylinder controlled the gas flowrate to the nozzle. Prior calibration provided the relationship between applied pressure and mass flowrate for each nozzle (the nozzle acted as a sonic orifice). The mass gas flowrate was verified after each run from the variation in the cylinder pressure that was measured by a transducer connected to a data acquisition system.

After injection, the fluidization gas was stopped in order to slump the bed. The fine particles collected in the cyclone were then returned to the bed. The fluidization gas was turned on again at a velocity just above the minimum bubbling velocity for approximately five minutes, in order to mix the particles. Previous experiments indicated that background particle attrition in the fluidized bed, in the absence of an attrition jet, was negligible when compared to the attrition observed with the nozzles. A sample of solids was taken from the bed before and after each run and analyzed using a Malvern laser diffraction apparatus to obtain the size distribution and the specific surface area created during the grinding process.

To compare the results, a grinding efficiency (E) was calculated and defined as the amount of new surface area created per mass of attrition gas used:

$$E = \frac{new particle surface created by attrition}{mass of attrition gas} = \frac{\frac{{m}^{2}}{s}}{\frac{kg}{s}} = \frac{{m}^{2}}{kg} \qquad ( 4 )$$

### Example 1

A Lexan® shroud with an interior diameter (D) of 44 mm was placed around the tip of the injection nozzle, as shown in FIG. 3. The nozzle height (h), defined as the distance between the tip of the nozzle and the base of the shroud, was 6.4 mm. Two shrouds were tested: one with a shroud height (H) of 51 mm and the other with a shroud height (H) of 19 mm. The jet angle (θ), defined as the angle between the periphery of the jet and a normal to the orifice, was calculated to be about 15 degrees. The orifice inner diameter (d) was 4.6 mm. Under these conditions, the grinding efficiency E without a shroud was 233 m²/kg. The results with a shroud are summarized in Table 2.

TABLE 2
Summary Data for the Effect of Shroud Length on Grinding Efficiency

| H (mm) | E (m²/kg) | C (mm) |
|---|---|---|
| 19 | 456 | 16.3 |
| 51 | 248 | 7.8 |

The grinding efficiencies obtained when a shroud was placed on the tip of the injection nozzle were higher than the free jet case, especially when the 19 mm long shroud was used. The shroud enhanced solids entrainment into the jet by creating a dense region of non-fluidized solids near the tip of the injection nozzle. The particles were constantly being entrained into the jet and replenished with fresh solids. One of the reasons why the 19 mm shroud performed better than the 51 mm shroud could be due to the fact that the shorter shroud allowed more solids to be entrained into the jet. The distance between the inside diameter of the shroud and the periphery of the jet (C) was greater for the shorter shroud. When the 51 mm shroud was used, the diameter of the gas jet at the exit of the shroud was only slightly smaller than the diameter of the shroud itself, thus restricting the space for solids to flow into the shroud and allowing fewer solids to be entrained into the jet.

### Example 2

The effect of nozzle orifice diameter on grinding efficiency was investigated for a free jet and a shrouded nozzle. Two orifice inner diameters (d) were studied: 2.4 mm and 4.6 mm. For the shrouded nozzle, the shroud had an interior diameter (D) of 44 mm, a nozzle height (h) of 6.4 mm, a shroud height (H) of 19 mm and a jet angle (θ) of 15 degrees. The results of experiments with these nozzles are presented in Table 3.

TABLE 3
Effect of Nozzle Scale on Grinding Efficiency

| | | ΔE_{shrouded} | |
|---|---|---|---|
| Nozzle Configuration | E (m²/kg) | (m²/kg) | C (mm) |
| Free Jet (d = 2.4 mm) | 197 | — | — |
| Shrouded Nozzle (d = 2.4 mm) | 350 | 153 | 17.4 |
| Free Jet (d = 4.6 mm) | 233 | — | — |
| Shrouded Nozzle (d = 4.6 mm) | 456 | 223 | 16.3 |

The 4.6 mm diameter orifice resulted in a much higher grinding efficiency than the 2.4 mm diameter orifice. An increase in grinding efficiency was achieved with the shroud for both orifice diameters. Surprisingly, the use of a shroud increased the grinding efficiency of the larger orifice by a much greater amount than for the smaller orifice. The change in grinding efficiency provided by the shroud for the larger nozzle was about 1.5 times that observed for the smaller nozzle. This suggests that the effect on grinding efficiency of increasing the nozzle size and adding a shroud were not just additive, but that some unexpected synergistic effect had also occurred. It is postulated that this may be due to the fact that the larger diameter nozzle has a higher flowrate, which in turn increases the pressure differential that causes the solids to entrain into the shroud.

### Example 3

A circular target constructed of stainless steel, with a diameter (D_{T}) of 76 mm was placed downstream of the shrouded nozzle, as shown in FIG. 4. Tests were performed with the target located at distances from the nozzle tip (l_{T}) of 63.5 mm, and 88.9 mm. The shroud had an interior diameter (D) of 44 mm, a nozzle height (h) of 6.4 mm, a shroud height (H) of 19 mm, an orifice diameter (d) of 4.6 mm and a jet angle (θ) of 15 degrees. The results are summarized in Table 4.

TABLE 4
Effect of Shroud and Target on Grinding Efficiency

| Condition | E (m²/kg) | C (mm) |
|---|---|---|
| Free Jet | 233 | — |
| Shroud | 456 | 16.3 |
| Shroud + Target (l_{T} = 63.5 mm) | 481 | 16.3 |
| Shroud + Target (l_{T} = 88.9 mm) | 497 | 16.3 |

For all cases, when the target was used the grinding efficiency was higher than the efficiency obtained with the free jet or the shrouded nozzle. The target provided a hard surface on which the particles could grind, thus increasing the grinding rate. In addition, the grinding efficiencies increased as the distance from the nozzle to the target was increased, up to a distance of 88.9 mm. The greater the distance between the nozzle and the target, the greater the volume of particles entrained into the jet, causing the grinding efficiency to increase.

### Example 4

A stainless steel draft tube with a length (L) of 50 mm and a diameter (D_{D}) of 25 mm was placed coaxially downstream of the injection nozzle, as shown in FIG. 5. The distance between the draft tube and the nozzle tip (l_{D}) was varied. Distances of 13 mm, 38 mm, 56 mm and 89 mm were tested. The shroud had an interior diameter (D) of 44 mm, a nozzle height (h) of 6.4 mm, a shroud height (H) of 19 mm, an orifice diameter (d) of 4.6 mm and a jet angle (θ) of 15 degrees. The results are summarized in Table 5.

TABLE 5
Effect of Shroud and Draft Tube on Grinding Efficiency

| Condition | E (m²/kg) | C (mm) |
|---|---|---|
| Free Jet | 233 | — |
| Shroud | 456 | 16.3 |
| Shroud + Draft Tube (l_{D} = 13 mm) | 298 | 16.3 |
| Shroud + Draft Tube (l_{D} = 38 mm) | 500 | 16.3 |
| Shroud + Draft Tube (l_{D} = 56 mm) | 476 | 16.3 |
| Shroud + Draft Tube (l_{D} = 89 mm) | 471 | 16.3 |

As reported in the literature, the use of a draft tube greatly enhanced the grinding as compared with a free jet. However, surprisingly, the addition of a shroud to the nozzle initially had a negative impact on grinding efficiency. When the draft tube was positioned approximately at the shroud opening, the grinding efficiency decreased by about one third. It is speculated that the draft tube interfered with the admission of solids into the interior of the shroud. As the distance between the shrouded nozzle and the draft tube was increased, the grinding efficiency also increased to a maximum observed at a distance of 38 mm. Once the 38 mm distance was exceeded, the jet began to diffuse and the width of the jet exceeded the width of the draft tube, both of which contributed to a loss of solids entrainment within the tube. Unexpectedly, the maximum grinding efficiency achieved with the draft tube and shroud (500 m²/kg) was only about 10% better than that achieved using the shroud by itself (456 m²/kg).

### Example 5

In order to investigate the effect of a shroud with a draft tube, further studies of the solids entrainment rate and fluidization gas entrainment rate were undertaken. The shroud used had an interior diameter (D) of 44 mm, a nozzle height (h) of 6.4 mm, an orifice diameter (d) of 4.6 mm and a jet angle (θ) of 12-15 degrees. The draft tube had a length (L) of 50 mm and a diameter (D_{D}) of 25 mm. The distance between the draft tube and injection nozzle (l_{D}) was varied. Distances of 25 mm, 38 mm and 76 mm were tested. The distance between the nozzle tip and the first end of the shroud (H−h) was expressed as a percentage of the total length between the nozzle tip and the draft tube (l_{D}) that was shrouded.

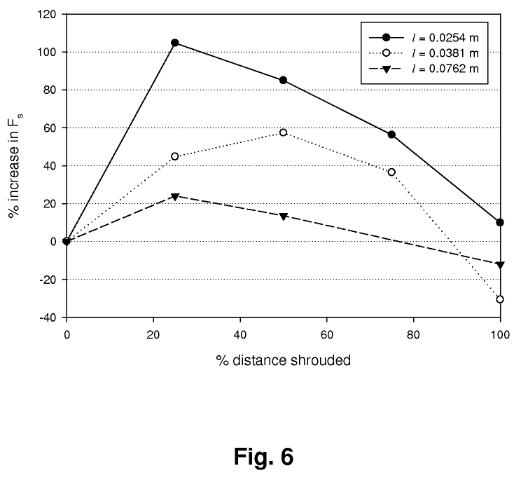

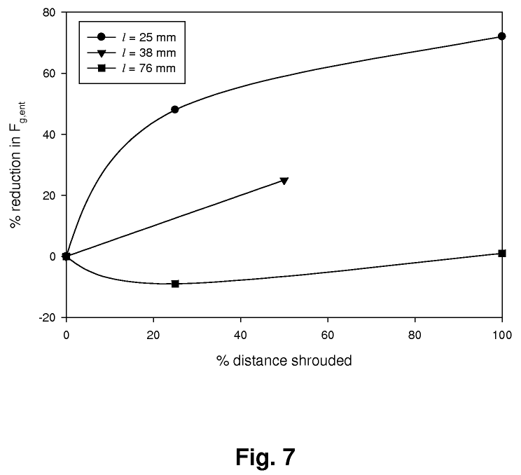

The entrainment of solids Fₛ is measured in units of mass flowrate (kg/s) and was expressed as a percentage improvement as compared with a base case of an unshrouded nozzle under otherwise identical conditions. The results for solids entrainment are presented in FIG. 6. In order to quantify the flow rate of fluidization gas entrained simultaneously with the solids, carbon dioxide (CO₂) tracer gas was injected upstream of the fluidized bed. The CO₂ concentration was measured using a Vaisala probe and transmitter (models GMP221 and GMT221, respectively). In order to protect the probe, the sampled gas first passed through a mesh screen placed flush with the pipe wall and then through a cellulose filter in order to screen out any solids carried over in the fluidization gas exit stream. The sampling line was maintained under vacuum at a flow rate of 6 scfh, well above the minimum flow rate required for operation of the probe. All tracer concentrations were averaged over a ten minute period once steady state had been reached (after approximately 20 min). From analysis of the gas samples, the amount of fluidization gas that was entrained with the gas injected into the draft tube could be determined. The results of these tracer studies are expressed in terms of a percentage reduction in fluidization gas entrainment as compared with a base case of an unshrouded nozzle under otherwise identical conditions. The results for solids entrainment are presented in FIG. 7.

FIG. 6 shows a considerable increase in solids entrainment of over 100% when the shroud is used as compared with the unshrouded case at a distance between nozzle tip and draft tube (l_{D}) of 25 mm with 25% of the distance shrouded (H−h=6 mm). However, as l_{D} increases, the incremental benefit of the presence of the shroud decreases to a maximum of about 60% for l_{D}=38 mm at 50% shrouded (H−h=19 mm) and about 22% for l_{D}=76 mm at 25% shrouded (H−h=19 mm).

FIG. 7 surprisingly shows that the increase in solids entrainment provided by the shroud also correlates with a reduction in fluidization gas entrainment. The greatest improvement in solids entrainment was achieved with l_{D} of 25 mm and, at 25% shrouded, the entrainment of fluidization gas was unexpectedly reduced by 45% as compared with the unshrouded case. Similarly, at l_{D} of 38 mm at 50% shrouded, the entrainment of fluidization gas was reduced by 25% as compared with the unshrouded case. Since the majority of entrainment occurs at the nozzle tip, the reduction in fluidization gas entrainment is indicative of a disengagement of fluidization gas from solids occurring within the interior of the shroud. Not only does the shroud increase solids entrainment (and hence, grinding efficiency), allowing a reduction in attrition jet flowrate to occur, but it also reduces the wasting of fluidization gas due to entrainment in the jet, thereby also reducing fluidization gas requirements. The overall effect is an energy savings in terms of gas delivery (and steam delivery in the fluid coking application).

### Example 6

In order to better understand the disengagement occurring in the interior of the shroud, visualization studies were undertaken both experimentally and using computational fluid dynamics (CFD) modeling.

A glass plate was placed in the side wall of the fluidized bed and a horizontal nozzle with d=1.6 mm was placed adjacent the plate. When there is no shroud, the solids were observed to move in “waves” or “pulses” towards the jet. The solids enter primarily at the nozzle tip (at a relatively higher velocity) but are also observed entering along the entire length of the jet. When a draft tube was added, entrained solids were redistributed from low velocity peripheral regions to the high velocity central region. The non-shrouded jet is relatively unstable as it interacts with the cross flow of fluidization gas and encounters rising bubbles, which divert the jet.

A half-cylindrical shroud was placed concentrically with the nozzle in a configuration as previously described. The change in flow patterns when the shroud is installed is quite striking. In this experiment, the solids were observed to move horizontally, countercurrent to the motive gas jet (even those solids already near the jet boundary) towards the nozzle tip located within the interior of the shroud. With the shroud, most of the solids appeared to be entrained near the nozzle tip rather than the periphery and the draft tube was not needed to transfer particles to the high velocity central region. The solids definitely moved faster above the jet than those below the jet (the countercurrent movement of which was still clearly visible) and the solid flow was smooth and constant. The shrouded jet was also observed to be narrower and more stable. No completely defluidized zones within the shroud were evident from visual observation, nor was there any solids accumulation. The jet penetration length of the shrouded jet was lower than that of the non-shrouded jet. This is attributed to the increased rate of solids entrainment into the shrouded jet, which would cause it to decelerate more rapidly. It was postulated from this visualization that the reason for decreased fluidization gas entrainment in the shrouded jet with draft tube configuration is due to a disengagement of gas from solids within the shroud prior to the solids entering the jet.

This postulate was supported by the CFD modeling results. The numerical simulations of particle entrainment into a submerged gas jet in a fluidized bed were conducted using the commercially available CFD software FLUENT (version 6.2.16). Both phases were treated as interpenetrating continua (i.e. Eulerian-Eulerian) and the phase interaction term (i.e. for the momentum transfer between phases) was described using a modified form of the Syamlal-O'Brien drag force model. The primary objective of this study was to investigate and gain insight into the gas-particle interaction and how the shroud affected the system hydrodynamics. Relatively strong recirculation zones of the gas phase were observed to form near the mouth of the shroud inlet; however, they were relatively weaker for the solid phase. This is indicative of disengagement of solids from fluidization gas within the interior of the shroud and is supported by both the CO₂ tracer studies and conventional glass plate visualization.

### Example 7

In order to increase the tendency for solids to move towards the nozzle tip in the shrouded configuration, experiments were conducted using a draft tube and a shroud having an inverted frustoconical interior shape, as shown in cross-section in FIG. 8. The solids entrainment rate for this shroud was compared with two other shroud configurations and with an unshrouded nozzle. The shroud parameters are provided in Table 6 and the experimental results are provided in Table 7 as a function of the distance between the nozzle tip and the draft tube (l_{D}).

TABLE 6
Shroud Parameters

| Shroud | D (mm) | H-h (mm) |
|---|---|---|
| No shroud | — | — |
| Shroud 1 (long and narrow) | 44 | 51 |
| Shroud 2 (short and wide) | 89 | 19 |
| Shroud 3 (inverted | 89 | 19 |
| frustoconical, wall angle 60°) | | |

TABLE 7
Solids Entrainment Results

| No Shroud | | Shroud 1 | | Shroud 2 | | Shroud 3 | |
|---|---|---|---|---|---|---|---|
| l_{D} | Fₛ | l_{D} | | l_{D} | | l_{D} | |
| (mm) | (kg/h) | (mm) | Fₛ (kg/h) | (mm) | Fₛ (kg/h) | (mm) | Fₛ (kg/h) |
| 0 | 586 | — | — | — | — | — | — |
| 44 | 493 | — | — | — | — | — | — |
| — | — | — | — | — | — | 51 | 852 |
| — | — | 57 | 805 | — | — | — | — |
| — | — | — | — | 64 | 770 | — | — |
| — | — | — | — | — | — | 76 | 914 |
| 89 | 360 | 89 | 998 | 89 | 909 | — | — |
| — | — | — | — | — | — | 102 | 865 |
| — | — | — | — | — | — | 127 | 807 |
| — | — | 146 | 959 | 146 | 760 | — | — |

In comparing the inverted frustoconical shroud (Shroud 3) with the closest comparable cylindrical shroud (Shroud 2), it can be seen that at similar l_{D} values Shroud 3 achieves a greater solids entrainment rate. Shroud 3 achieves a greater maximum solids entrainment rate and that this maximum occurs at a lower l_{D} value than for Shroud 2. However, Shroud 3 performed about as well as Shroud 1 at low l_{D} values, but did not attain as high of a maximum solids entrainment rate. All of the shrouded nozzles outperformed the un-shrouded nozzle.

### Example 8

The solids entrainment rate of the horizontal nozzles used throughout the preceding experiments was compared with that of vertical nozzles under certain selected conditions. A horizontal jet without a shroud was found to entrain about 3 times more solids than a vertical jet without a shroud under similar conditions. A horizontal jet with a shroud was found to entrain 6 times more solids than a vertical jet with a shroud. A horizontal jet with a shroud increased the entrainment rate of solids by 100% in the best case as compared with an unshrouded nozzle, whereas the vertical jet with a shroud increased the entrainment rate of solids by 70% in the best case. Vertical jets with shrouds outperformed unshrouded vertical jets in all cases.

The foregoing describes preferred embodiments of the invention and other features and embodiments of the invention will be evident to persons skilled in the art. The following claims are to be construed broadly with reference to the foregoing and are intended by the inventor to include other variations and sub-combinations, even if not explicitly claimed.

1. A shrouded attrition nozzle for use in a vessel containing a fluidized bed of a fluidizable media, the nozzle comprising:
(a) a nozzle body having a nozzle height and an orifice at one end with an inner diameter for emitting a high velocity gas jet into the fluidized bed, the gas jet having a jet angle between a periphery of the jet and a normal to the orifice;
(b) a shroud having a shroud height, an interior within which the nozzle body is centrally located, an interior diameter, a first end that is open and a second end that prevents passage of the media into the interior;
(c) the relationship between the nozzle height (h), the orifice inner diameter (d), the jet angle (θ), the shroud height (H) and the shroud interior diameter (D) defined by,
$$C = \frac{D - d}{2} - ( H - h ) tan ( θ )$$
wherein C represents the distance between the periphery of the jet and the shroud across the first end and is from 1 to 100 mm.

2. The shrouded attrition nozzle of claim 1, wherein the second end is closed and wherein the shroud is attached to the nozzle body.

3. The shrouded attrition nozzle of claim 1, wherein the second end abuts an interior surface of the vessel when the nozzle is in use, thereby preventing passage of the fluidizable media between the surface and the second end.

4. The shrouded attrition nozzle of claim 1, wherein the fluidizable media is able to enter the interior of the shroud only through the first end.

5. The shrouded attrition nozzle of claim 1, wherein the shroud is cylindrical or inverted frustoconical in shape.

6. The shrouded attrition nozzle of claim 1, wherein the jet is inverted conical, inverted frustoconical or fan shaped.

7. The shrouded attrition nozzle of claim 1, wherein the jet angle (θ) is from 10 to 20 degrees.

8. The shrouded attrition nozzle of claim 1, wherein C is from 5 to 50 mm.

9. The shrouded attrition nozzle of claim 1, wherein the jet angle (θ) is from 12 to 18 degrees and wherein C is from 5 to 20 mm.

10. The shrouded attrition nozzle of claim 1, wherein the shroud interior diameter (D) is from 30 to 90 mm.

11. The shrouded attrition nozzle of claim 1, wherein the shroud height (H) is from 10 to 80 mm.

12. A method of causing attrition of a fluidizable media comprising:
(a) providing a vessel containing a fluidizable media and a shrouded attrition nozzle comprising a nozzle body having an orifice at one end and a shroud having an interior within which the nozzle body is centrally located, a first end that is open and a second end that prevents passage of the media into the interior;
(b) creating a fluidized bed by flowing a fluidizing gas through the fluidizable media within the vessel;
(c) directing a flow of gas through the nozzle body;
(d) emitting a high velocity gas jet from the orifice into the fluidized bed;
(e) admitting the fluidizable media into the interior of the shroud through the first end; and,
(f) entraining the admitted media with the jet at high velocity into the fluidized bed, thereby causing attrition of the media.

13. The method of claim 12, wherein the fluidizable media is admitted into the interior of the shroud only through the first end.

14. The shrouded attrition nozzle of claim 12, wherein the nozzle is mounted horizontally

15. The shrouded attrition nozzle of claim 12, wherein the nozzle is mounted vertically

16. The method of claim 12, wherein the vessel further comprises a target spaced apart from the first end of the shroud and transverse to the jet.

17. The method of claim 12, wherein the vessel further comprises a draft tube spaced apart from the first end of the shroud and aligned with the jet and wherein the admitted media is entrained with the jet into the draft tube.

18. The method of claim 17, wherein the draft tube is located from 10 to 150 mm from the orifice.

19. The method of claim 12, wherein the fluidizing gas disengages from the fluidizable material within the interior of the shroud.

20. The method of claim 12, wherein the fluidizable material moves countercurrent to the jet within the shroud toward the orifice.
